(19) United States
(12) Patent Application Publication
(10) Pub. No.: US 2014/0188604 A1
(43) Pub. Date: Jul. 3, 2014

(54) System and Method for Targeted Advertisement and Improving Customer Satisfaction

(71) Applicant: Gabrielle Gloria MUIR, New York, NY (US)

(72) Inventor: Gabrielle Gloria MUIR, New York, NY (US)

(21) Appl. No.: 13/839,819

(22) Filed: Mar. 15, 2013

Related U.S. Application Data
(60) Provisional application No. 61/746,989, filed on Dec. 28, 2012.

(51) Int. Cl. G06Q 30/02

(52) U.S. Cl. CPC G06Q 30/0253
USPC 705/14.51

(57) ABSTRACT

A comprehensive suite of tools to ensure improved customer satisfaction. Tools are provided for designing a room; obtaining blogger information to help in product selections (influence of bloggers); Selecting furniture—see it in your space; sharing the design for comment by others; making sure furniture fits through doors and room passages and shipping the furniture with targeted third party advertisements.

### CLAIM TO PRIORITY

This application claims the benefit of U.S. Provisional Patent Application Ser. No. 61/746,989 filed Dec. 28, 2012 which is herein incorporated by reference in its entirety.

### FIELD OF INVENTION

The invention relates to online commerce especially in the context of interior design and targeted advertising.

### BACKGROUND

The Internet commerce industry has developed rapidly in recent years. Rather than having to physically go to a store to purchase a product and transport it home, customers are able to purchase a product from a merchant's website and have it delivered to them by a shipping carrier, such as United Parcel Service (UPS™), Federal Express (FedEx™), DHL™, and the United States Postal Service (USPS™).

Customers receive millions of shipping boxes and envelopes every day. Presently, there is no a targeted advertising available delivery box or envelopes that is offered to shippers and/or third party advertisers and that is directed to the customers who utilize the relevant purchase just made. Thus, there is a substantial avenue for brand promotion and advertising that is currently going untapped.

Existing methods of providing advertisements do not provide an effective method for targeting the relevant interests of the consumers and other potential shoppers (delivery people, doorman etc) that directly or indirectly access see receive these deliveries.

Of course, the Internet is used for far more than merely ordering products. Customers rely on the internet to obtain information that influences purchasing decisions. Online reviews and “blogs” are an important source of such information.

### SUMMARY

The present invention provides a system and method for targeted advertisement and improving customer satisfaction. The invention further provides systems and methods for leveraging information available in electronic commerce to improve customer satisfaction by ensuring, for example, that products “fit” thorough doorways (and other passages) and that items “look right” in a room.

The system and method provide a comprehensive suite of tools to ensure improved customer satisfaction. The system may include the following components and sub systems that have value individually and in combination. Sub systems include systems for:
Designing a room
   Choose your design tool (template, generic room, actual room, dream room)
   Add the Background
Obtaining blogger information to help in product selections (influence of bloggers)
Selecting furniture—see it in your space
Share the design for comment by others
Making sure furniture fits through doors and room passages
Ship furniture with targeted third party advertisements.

The targeted advertising processing may include the following steps: the system receives and stores an AD LAYOUT; At step 120, the system the system receives and stores an AD TARGET; the system receives a CUSTOMER ORDER. The CUSTOMER ORDER includes information such as shipping address (ZIP CODE); PRODUCT ID and/or CUSTOMER ID that can be used to target advertising. Next, the system determines whether the CUSTOMER ORDER matches an AD TARGET. If not, the system records the “lost opportunity” and proceeds with shipping.

When the CUSTOMER ORDER matches an AD TARGET, the system determines whether more than one AD TARGET match has been made. If more than one AD TARGET match has been made, the AD TARGET conflict resolution engine determines which AD or ADS will be used. Next the system retrieves the stored AD LAYOUT associated with each of the selected ad(s) and the system applies the selected AD LAYOUT to shipping packaging. Finally, the system updates accounting records to reflect that an advertisement has been made and shipping proceeds.

### BRIEF DESCRIPTION

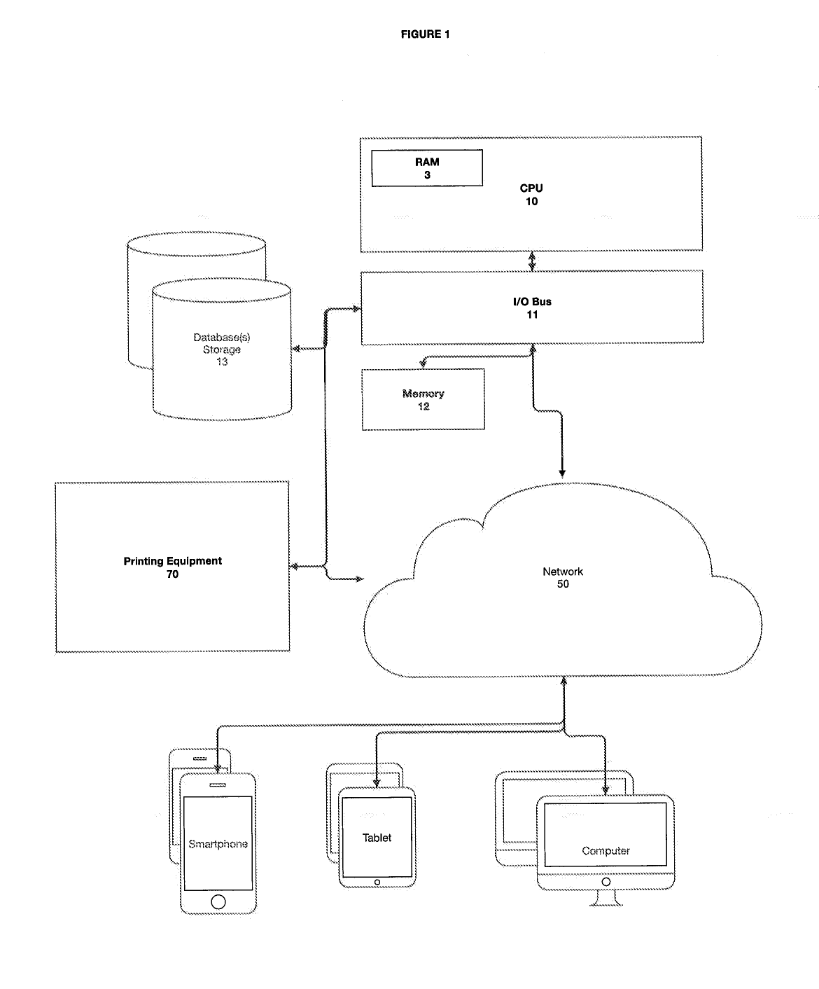

FIG. 1 is a system layout diagram showing the system of the present invention.

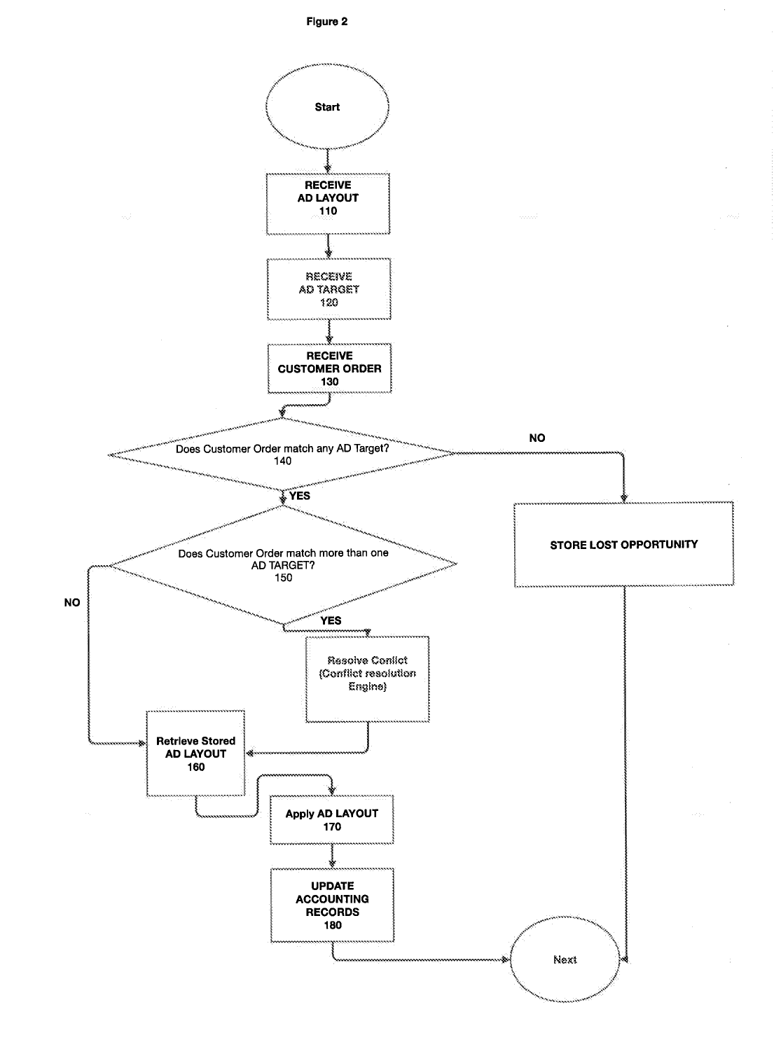

FIG. 2 is a flowchart showing the method of the present invention.

### DETAILED DESCRIPTION

### Targeted Advertising on Shipping Materials

As shown in FIG. 1, the system of the present includes a general purpose CPU 10 and I/O Bus for communicating with various hardware and network resources. The CPU 10 which may include onboard memory communicate through the I/O Bus with

FIG. 1 depicts the System Architecture of an embodiment of the invention. The hardware includes a CPU 10 with on board RAM 3; an input/output system bus 11 (including control bus, address bus and data bus functionality); system memory 12; system storage 13 (flash or hard drive); a network communication equipment for enabling wired, Wi-Fi, Bluetooth and/or other data exchange over a local or global information network 50. Printing equipment 70 communicates over the network 50. This architecture allows the system to receive process and send data over the Global Information Network (GIN). The CPU runs software to perform the process of the present invention as described below. If desired, dedicated software engines may be used.

FIG. 2 shows the process flow of the present invention.

At step 110, the system receives and stores an AD LAYOUT.

At step 120, the system the system receives and stores an AD TARGET

At step 130, the system receives a CUSTOMER ORDER. The CUSTOMER ORDER includes information such as shipping address (ZIP CODE); PRODUCT ID and/or CUSTOMER ID that can be used to target advertising.

At step 140, the system determines whether the CUSTOMER ORDER matches an AD TARGET. If not, the system records the “lost opportunity” and proceeds with shipping.

When the CUSTOMER ORDER matches an AD TARGET (at step 150), the system determines whether more than one AD TARGET match has been made. If more than one AD TARGET match has been made, the AD TARGET conflict resolution engine determines which AD or ADS will be used.

At step 160, the system retrieves the stored AD LAYOUT associated with each of the selected ad(s).

At step 170, the system applies the selected AD LAYOUT to shipping packaging.

At step 180, the system updates accounting records to reflect that an advertisement has been made.

At step 190, the shipping proceeds as normal.

These steps are preferably implemented on a specially programmed general purpose computer system and associated hardware (printing, communication and data storage) described further hereinafter.

Step 110, in which the system receives and stores an AD LAYOUT, may include receiving input from an advertiser in real time through the internet or retrieving and storing a selection or layout to be used later. The advertiser specifies how they want the ad to look either by uploading a file, selecting from predetermined options (“build your own ad”) or providing artwork to be converted to a file. Any advertiser may store more than one AD LAYOUT, but they should then specify which Ads should be used and when, i.e., input AD LAYOUT selection criteria. The system preferably includes a bar code generator to allow the advertiser the option of including a QR code or similar type of matrix barcode (two-dimensional bar code) as part of the AD LAYOUT. In this way, the AD LAYOUT can be linked closely with a website location.

Step 120, in which the system receives and stores an AD TARGET entails receiving and storing advertiser selections as to whom ads should be sent to. Because the ads will be applied to shipping packages in response to CUSTOMER ORDERS it is preferably to use AD TARGETs based on information that is commonly known when shipping items. Thus, for example, an advertiser may choose have its AD LAYOUT applied to packages sent to a certain geographic area (by ZIP CODE, for example); or to any packages containing certain types of products (identified by PRODUCT ID) or to customers that meet certain known criteria (typically provided by the customer and stored by CUSTOMER ID). By way of example only, an AD for a local health food store could be applied to packaging for books on healthy diets that are sent to person living in the area. Likewise the AD LAYOUT of a local sporting goods retailer could be applied to the packaging of golf balls or books on golfing sent to customers in the area.

Step 130, in which the system receives a CUSTOMER ORDER in which the CUSTOMER ORDER includes information such as shipping address (ZIP CODE); PRODUCT ID and/or CUSTOMER ID that can be used to target advertising, involves receiving information relating to online orders that are ready for shipping. The system may be integrated into an existing order processing system or receive a separate data feed from an order processing system.

Step 140, in which the system determines whether the CUSTOMER ORDER matches an AD TARGET involves a search of the stored AD TARGET information using information from the CUSTOMER ORDER. If no match is found, the system may optionally record details to the transaction as a “lost opportunity” for targeted advertising. When the CUSTOMER ORDER matches an AD TARGET (at step 150), the system next determines whether more than one AD TARGET match has been made. If more than one AD TARGET match has been made, the AD TARGET conflict resolution engine determines which AD or ADS will be used.

When more than one advertiser has expressed an interest (though AD TARGET selections) in placing their AD LAYOUT on a single shipment, a conflict arises and the system must resolve the conflict using a conflict resolution engine. The conflict resolution engine relies on information provided by advertisers to resolve conflicts. For example, advertisers may specify a maximum amount they will pay for an ad in which case the AD LAYOUT of the “high bidder” is given preference. The AD LAYOUTS may be alternated according to a set plan. Advertisers may agree in advance that they will share AD LAYOUT space under certain conditions (e.g., not competing products). The conflict resolution engine stores any such arrangement as conflict resolution rules and applies the rules to determine which AD LAYOUT (or layouts) is to be applied.

Step 160, in which the system retrieves and formats the stored AD LAYOUT associated with each of the selected ad(s) involves receiving input as to the size of the packaging and number of ads to be applied and then formatting the AD LAYOUTS for application to the packaging.

Step 170, in which the system applies the selected AD LAYOUT to shipping packaging could involve printing directly onto the packaging (preferably along with printing the relevant shipping address information). Alternatively, the AD LAYOUT could be printed as part of a label applied directly to the packaging and visible when the package is unopened.

Step 180, in which the system updates accounting records to reflect that an advertisement has been made involves storing information that allows the system operator to make reports to and charge the advertiser(s) for the ads applied to packages.

At step 190, shipping proceeds as normal with the AD LAYOUTS applied to the packaging. Upon receipt of the package, a customer may use the bar code to access information from the advertiser.

Other business arrangements are possible. For example, an advertiser may agree to subsidize a portion of or the entire cost of package materials (for example, boxes) that include their advertisements. Thus, a company that ships many packages may reduce their cost by allowing third party advertising on the packages.

One or more advertisements are selected from the advertisement database (step S36). For example, the advertisements may be selected based upon the delivery address (e.g., city, state, zip code, country), and may also be based on one or more details of the transaction and/or client information.

The advertisements may include text, graphics, pictures, animations, promotional information, and the like. The advertisements may be in the form of an impression, a banner advertisement, and the like.

To bill the advertiser for the advertisement. The advertisement may be charged to the advertiser's advertisement account, bank account, valid credit card, etc. The advertiser may be charged when their advertisements are 1. selected and approved before printing, 2. Delivered etc.

A second advertisement is a is a text string including the advertiser's name

According to one embodiment, a system for providing directed advertising on a box or envelope includes delivery box and or envelope and an advertisement system.

The advertisement system receives advertisements, categorizes the received advertisements based on preselected criteria, and selects an advertisement based on the preselected criteria.

For example, the advertiser can set the advertisement selection criteria so that an advertisement is selected to be displayed with shipping orders in which the shipper is involved in a particular non-conflicting type of business or for shipping orders in which the recipient has a delivery address in a particular zip code, thereby directing the advertisement to a specific non-conflicting type of business or specific geographic area, respectively.

The advertiser can also set limits on when the advertisement is to be selected for display. For example, the advertiser can select the time frame for which the advertisement is to be displayed, which may include a range of dates, days of the week, and/or times. For example, the advertisement could be run from January 1 through February 15, only on Mondays through Fridays, from 6:00 pm to 11:00 pm. The advertiser can also select a limit on how many times an advertisement is to be selected in a designated time period.

The shipping carrier can allow the advertiser to agree to a price (e.g., flat rate, bid, etc.) that will be charged each time an advertisement is displayed, which will be charged to the advertiser by the billing system 152. However, the shipping carrier can also allow for the display of advertisements free of charge, for example, as an additional incentive to a shipper to use their services.

Free, subsidized, incentives and or reciprocal with their partners and or large clients.—eg electroulux . . . sub zero . . . tide

Material of the delivery boxes?

Printing boxes very affordable
Stickers
Mylar
decals
tape printed

Ways to pay.

Set price.

Maximum bid . . . if they get anything at the last minute.

Numbers, minimum,

stickers can produce and send when they want, low storage.

different shapes
1. Is the company itself, bed bath and beyond.
   Partner reciprocal company.
   3rd party.
2. Fullfiller like amazon, can do it for company that it doesn't own as a fullfilment option.

Sustainable.

More recyclable, subsidized by this advertiser.

### Blogger Referrals

Another tool according to the present invention is a system for using blogger referrals to promote products.

### Bloggers

Our company wants to maximize the most of these blog sites. They write, entice you to have it, yet they don't sell it or make money by generating leads. They have all the email addresses of people who are specifically interested. It would only benefit them, no canabilism because they don't do sales. Yet people follow there reviews religiously. Unused massive resource.!

### Reviews

Links to blogs who have written about it.

Slogs seem more than willing to share this knowledge, however they seem reluctant to make it a convention all commercial business because of other commitments or creditability concerns.

The reason this is important is the blogger has the choice what to do with the discount pass on fully to there followers and remain “above” the commercialism. Or pass on to charity, share with there followers and or keep the lot for themselves.

A sister company that deals 100% with bloggers and other writers, reviewers who want to receive benefits for themselves or to pass on to there followers.

The company has a selection of products and services, with what discount and or benefit they will offer depending on the volume and or new subscribers, underneath the product or service.

Bloggers and or other writers can come to this site to see what products and or service they want to write about! review and share with there followers and receive the corresponding benefit/discount/rebate that they choose if they split or pass on the full discount to followers who make a purchase.

### Blogger/Writer World.

Companies can list their products or services on our site. They will be categorized (eg furniture, sports equipment etc) Like Ebay. However instead of the products/services being for sale they will have a benefit next to them that you will receive for selling/promoting them via.
Blogger site
Writers reviewing.
Individuals and there personal or other contacts.
Companies to there employees or other contacts.
Advertising newspapers or online sites.
   The technology will be similar to ebay, listing an item for sale.
   1 Put in the picture of the item/brand/service.
   2 Fill in a description adding any PR copy
   3 Similar payment fee to ebay either you get charged an upfront fee or a % of the item you are listing to our company in addition to the benefit you are offering or not.
   4 Fill in the specific details of your offer eg the price and offers depending on volume. or how many people need to become member of your company.
   online patent business, . . . delivery box's
   What I have searched under to find something similar.
   advertising and placement and shipping and boxes and third and party (258 hits)
   Advertising and on and boxes and for and third and parties (no hits)
   Advertising and on and boxes (23 hits)
   (delivery AND boxes) AND Advertising) AND Third) AND party). (1703 hits)
   advertising and third and party and shipping and boxes

### Room Design Tool

Online business Lookstar

### Company Overview

Lookstar is here to help people create an entire house or a single room of their dreams. Lookstar is like having a best friend who's an interior designer with the best international interior designer contacts at one's finger tips. The best friend/international star team has tremendous resources to create the environment in which the client wants to live. It is the client's personality reflected with the help of the designer's expertise. Lookstar offers wonderful strategies and solutions for people without retaining the services of an interior designer.

Interior design is a creative process and Lookstar's collaborative environment and easy to identify categories turn dreams into reality. Lookstar's Categorier offers the world of home furnishings reduced to a tantalizing menu. The Categorizer finds the shopper's dream piece, in the dream color, at the dream price. The creative experience belongs to the user who sees it, drags it into the online room, changes It, refines it sees that it fits, shares it on social media, buys it, gets it and loves it.

Lookstar is a wholesaler of brands that our design team has categorized and curated for the purpose of helping people on this important major investment decision of purchasing home furnishings with a general lifetime expectation of 12 years.

For every creation the user has the ability to share the creation with friends and family through social media.

Lookstar offers users their dream view of what is possible when they use one or more of

Lookstar's five (5) tools. Let's start with the simplest:

Template: From a group of six templates1 the user identifies the room and selects the background color for the room from our handpicked Benjamin Moore color palette, or wallpaper selection. Now the user sees how the room's content looks on the page.
Differences from Existing Sites:

Set up dedicated rooms, like living, bedroom, nursery etc So it looks more like the actual room you are creating, rather than random placement like the other companies. It gives you suggested predetermined spaces, that a relevant to where an interior designer would place them.

On the blank page template, we have a layering effect software. ie so the back ground is put in first, then you put on the layers of photos so it becomes more realistic.
First you put the paint color or wallpaper, then when you put the curtains on next it will realistically cover some of the first photo, (now you will see what your curtains look like on the wall color) then you layer with another photo eg a sofa which will then cover some of the first and 2nd photo (wall color and curtain), so it gives a more realistic view of what your sofa will look like in front of your curtains and wall color) and you keep going till you get a realistic idea of how the pieces will look in their right spacial context.

We will have templates of the most awe inspiring rooms to fill, eg Plaza . . . high ceilings, gorgeous plaster work, etc. Architectural rooms that would have people dreaming about filling with furniture—next best thing if you are not going to have it.

Example: Living Room

[insert graphic with boxes named]

Basket [if we can get the technology for items to bend over the basket, otherwise a blank page]

Using a traditional design technique, the user selects from Lookstar's vast product library of visuals and drags each item for the room into the basket, shrinks or enlarges and moves the items to their desired space to see how they look together and if the result provides the desired effect.

[Insert graphic with fabric sample, paint chip(s) for room color and accents and textiles and furniture.)

Generic Room: From a Lookstar selection of room shapes, the user provides the ceiling height and one of the dimensions (width or length) and the program scales the room to its proper proportions. The best part of this feature is that selected items automatically scale to your room and to each other. Now the user can move each item to different locations to create a variety of floor plans. In addition, the user can upload photos of key pieces of existing furniture to ensure they work together.

[Insert graphic showing empty room with dimensions and then a room with selected items]

Exact Room: Lookstar enables the user to upload a photo of the exact room that's ready for design. Once you input two of the three dimensions (ceiling and length of room ceiling and width of room) Lookstar converts the two dimensional photo of the room to 30 providing a life like view of their room. Now when the user selects items for the room, they appear in full dimension.

[Insert graphic of a 30 room with furniture showing person in room looking at effect on computer screen]

### Best Online Design Friend/Best Friend: The Interior Designer

The user who wants professional advice can ask Lookstar to provide the help of the Lookstar team of interior designers. From a carefully designed questionnaire the user fills out, including a budget, plus any items in any or all of the other rooms the user has tried, the creative team of designers works as a group to pull together three alternative designs that offer the amalgam of good design and flair the user has identified. If the user doesn't absolutely love it, a conference call with a designer will be arranged to go over the questionnaire and the offered room designs to enable the designer to present additional storyboards.

### Additional Tools

Lookstar offers many additional tools for the user to select items to fall in love with.
Product Reviews from outside sources and Lookstar Reviews from

Lookstar's team of designer
Product review from your favorite design and renovation blogs.
Budget Totalizer to help user determine the timeframe in which the project will be done. Lookstar guarantees that the amount identified for the products is the amount the user pays.
GPS locator in user's smart phone pings when a store carrying any of the items the user has identified from Lookstar's library for their project.
Customized Benjamin Moore paint colors and expertise of designer team regarding which colors and which furniture pieces work together. Shoppers who choose a piece of furniture for their room can click on a paint bucket icon for Lookstar's custom paint colors that go spectacularly with that color.
Users who select a piece of furniture can click on a xoxox icon to discover other categories and pieces in colors that coordinate. These may include other pieces of furniture. curtains, rugs, accessories, etc. For users who decide they love a color, they can look to Lookstar to recommend colors within the same color wave or family of colors.
The Categorizer simplifies your design decisions. Out of the world of items such as sofas, the Lookstar team has cherry picked the best of the best and organized it by category. This means even our vast library is categorized to make the process simple. These categories include:
1. Lookstar's must-haves
1. color
2. high-low items (the top design look at great prices)
3. kid and pet friendly
4. understated elegance
5. period (traditional, mid-century, modern, contemporary)
6. spectacular specials (items at fabulous prices but quantities are limited)
7. favorite interior designers (Barbara Barry, Eric Cohler)
8. favorite brands (
9. Furniture pieces (sofas, tables, chairs, beds)
10. Textiles and rugs (curtains)
11. Accessories (pillows)
12. rooms (bedroom, living room, children, nursery)
13. lighting (lamp, floor, ceiling)
14. entertainment centers
15. first time renter/student
16. staged rooms for selling home
17. feminine glamorous
18. James Bond bachelor
   Solution . . . [whats unique about our product and how it solves issues.]

Making the world of design accessible in an organized for easy and pleasurable use . . . we are making it fun.

This converts a chore into a fun activity. it broadens the users

Lookstar provides the tools that are closest to having ones own personal interior designer. It enable s you to get what you want to express yourself. Using lookstars tools provide you with the assuredness of knowing what it is going to look like in your space. The doubt disappears, the creativity and fun starts.

We give you a great eye . . . to see exactly what sit is going to look like in your space, with your things.

You have the confidence to pull the trigger . . . bite the bullet . . . make the purchase instead of procrastinating and being unhappy with how your home looks.

So you get the high of satisfaction that you did it yourself,

Another advantage the shopper obtains is a cohesive plan that they love, yet depending on finance or budget they have the flexibility to purchase when they want, all together or piece by piece.

Shopper has total discretion and control of when they buy either all at once house full, several pieces room full, or an individual item, or even the first step of creating a dream list.

Shopper feels that their new best friend is Lookstar, who just happens to be an interior designer

### Target Market

Interior designers, who sell to clients.

91% of people in America who have never talked to or worked with an interior designer to help with the creative process for buying home furnishings,

one stop shopping for all items, {with every thing from seeing the visuals,/to the proportion of items in the room, to how the new items would mix with the existing items, reviews, ability to share your look for feedback thru social media, to be able to create a variety of layouts with the same furniture to optimize the positioning, to which combination of furniture looks best together, gps locator on your smart phone, when you are near your desired item. to being able to purchase. Like tech support except interior designer support line. Available online or phone. Interior design appointments like the apple booker to access the Lookstar designer team Lookstar organized as a wholesaler for pricing advantages from manufacturers.

### Ease of Use

Lookstar selects the best brands and then cherry picks the best items in each brand and uses the Categorizer tool to organize selections. Once the user goes on the site the user experiences a conversation that for all intents and purposes is like talking to an interior designer. Example: The user indicates s/he is looking for a dining room table.

The next question may be “is your dining a time you have talks and discussions?” In this way the Organizer narrows the virtual library to tailor selections to how the user expects to enjoy the table in his/her life. The Categorizer enters Lookstar's curated library, inputs the user's numerous specifications and tailors the table selections to this client.

All in one place, so you don't have to go to different sites.

### Tools [Listed Elsewhere].

Categoriser . . . 1) making the vast library user friendly. 2) that our team has already cherry picked the best by variety of category, ie different, budgets, style, size, color, etc

Visual assister; template and baskets

Actual room size dimensions of the generic room and 3D room

Door which has your minimum door size on it and you see the items go thru so you know they fit.

Paint bucket icon, which sits next to items to show the user Lookstar highly recommended custom paint color choices for that particular item

Reviews from outside and internal design team. When you click on an item the reviews are there.

### GPS Locator

Interior designer access; with there 20% discount with so many benefits to make their life easier like 20% discount

When the item gets sent to the client, it will not have an invoice in the package, so—the designer is free to mark up however much they want.

They get the free use of the tools to show those clients who have difficulty visualizing to provide visualization.

Special billing section where they can segment their orders by clients thus reduces the paper work and managers the accounts so they can see that particular clients purchases all in one spot.

Reach out to a dedicated Lookstar representative with the vendor to facilitate orders. Free shipping

Also links in to our other favorite vendors globally, so it broadens the scope of where they are resourcing from

All in one place, so you don't have to go to different sites.

Vital differentiate

To see the prospective items in a replica of your exact room proportions. There are 2 ways to achieve this visual.

Is to provide 2 of the 3 measurements (ceiling height, width of room or length of room), This is to create the proportions of your room, online,
1. Generic Room: From a Lookstar selection of room shapes, the user provides the ::.—ceiling height and one of the dimensions (width or length) and the program scales the room to its proper proportions. The best part of this feature is that selected items automatically scale to your room and to each other. Now the user can move each item to different locations to create a variety of floor plans. In addition, the user can upload photos of key pieces of existing furniture to ensure they work together.
2. Exact Room: Lookstar enables the user to upload a photo of the exact room that's ready for design. Once you input two of the three dimensions (ceiling and length of room ceiling and width of room) Lookstar converts the two dimensional photo of the room to 30 providing a life like view of their room. Now when the user selects items for the room, they appear in full dimension.

[Insert graphic of a 30 room with furniture showing person in room looking at effect on computer screen]

Just like you bring your body to try on clothes to see how they fit and how you like them and if the colors are good.

Lookstar enables the shopper to do the same for each and every room by bringing the room and piece together.

An analogy would be To bring the room or the home into the walk in closet room.

Think of the most beautiful fitting dressing room you can imagine and here are a few we like. . . .

Just as the feeling you get when you imagine a beautifully, curated wardrobe just for your body. Lookstar lets you design your room with perfectly curated pieces for your dream home.

Skin and how things look on you

Just as the shopper in the fitting room assess's the color of the garment next to their own skin. The Lookstar shopper can assess there prospective purchase against the color of their walls and along side other potential new or existing furniture. To assist in this assessment a variety of apps and or icons are available on the site located near that item identified to paint and or wallpaper the walls.

### Changes to Compare

Just as you can bring in several changes into a fitting room with Lookstar you can try on other alternatives to your hearts content, saving each one as you go in your personal gallery to then compare

In the shoppers“fitting room”,

This showcasing of the room and the items selected from the Lookstar library.

How project decor has different brands, however our business method is to show case the items in a proportioned room, so you can actually see how they look and fit, this feature may be seen in 2d or 3d

We are offering our unique visualization tools and selection to help the shopper come to a decision. The virtual item, with Lookstars tools can be seen just as if it is in your room. ie the sofa the shopper is considering for purchase may be virtually dragged into the room to
1. See proportionally how it fits (no 1 difficulty for shoppers to visualise). If it is too small or if it dominates the room too much.
2. How it works with existing furniture.

Now that embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

1. A targeted advertising method for use in a system comprising a general purpose connected to a communications and printing equipment, the method comprising the steps of:
receiving and storing an AD LAYOUT;
receiving and storing an AD TARGET;
receiving a CUSTOMER ORDER;
determining whether the CUSTOMER ORDER matches an AD TARGET;
retrieving the stored AD LAYOUT associated with each selected ad; and
applying the selected AD LAYOUT to shipping packaging.

2. The method of claim 1, further comprising the step of updating accounting records to reflect that an advertisement has been made.

3. The method of claim 1, wherein when the CUSTOMER ORDER matches an AD TARGET performing the further step of determining whether more than one AD TARGET match has been made.

4. The method of claim 3, comprising the further step of using a conflict resolution engine determines which AD or ADS will be used.
